(19) United States
(12) Patent Application Publication
(10) Pub. No.: US 2016/0059825 A1
(43) Pub. Date: Mar. 3, 2016

(54) VEHICLE ANTI-THEFT APPARATUS AND METHOD

(71) Applicant: CATERPILLAR INC., Peoria, IL (US)

(72) Inventor: Edwin COOMBS, Leamington Spa. (GB)

(73) Assignee: CATERPILLAR INC., Peoria, IL (US)

(21) Appl. No.: 14/888,562

(22) PCT Filed: May 8, 2014
(86) PCT No.: PCT/US2014/037273

§ 371 Date: Nov. 2, 2015

(30) Foreign Application Priority Data
May 8, 2013 (GB) 1308246.6

(51) Int. Cl. B60R 25/06; B60R 25/23

(52) U.S. Cl. CPC B60R 25/06; B60R 25/23; B60R 2025/0415

(57) ABSTRACT

A vehicle immobiliser having an input device configured to receive a code and an output device configured to issue an instruction to a controller of a vehicle is disclosed. The vehicle immobiliser may be configured to prevent an operation of the vehicle when the vehicle immobiliser is armed and allow an operation of the vehicle when the vehicle immobiliser is disarmed. The vehicle immobiliser may also be configured to operate in a first life-state and a subsequent second life-state. The vehicle immobiliser may enter the second life-state only after being disarmed in the first life-state. When the vehicle immobiliser is armed and in a first life-state, the vehicle immobiliser may be disarmed upon receiving the code that satisfies a first disarming condition. Similarly, when the vehicle immobiliser is armed and in a second life-state, the vehicle immobiliser may be disarmed upon receiving the code that satisfies a second disarming condition.

### TECHNICAL FIELD

The present disclosure relates to a vehicle anti-theft apparatus and method.

### BACKGROUND

In order to help prevent the theft of a vehicle, an electronic vehicle immobiliser may be fitted to the vehicle. The immobiliser may interface with an electronic control unit (ECU) and/or engine such that whilst the immobiliser is armed, the ECU can be instructed to prevent at least one operation essential to the starting and operation of the vehicle, for example engine ignition, operation of the transmission or operation of the fuel pumps, etc. The immobiliser may be disarmed by the user inputting a disarm code, after which the engine and/or other machine functions may be allowed to perform all operations required for starting and operating the vehicle. The immobiliser may be incorporated with the ECU and engine at the time of vehicle manufacture, or it may be added to the vehicle at any time after manufacture.

The disarm code may be entered by a number of different means, for example via a keypad, a wireless key-fob, an RFID tag etc. The entered disarm code may be compared with a saved disarm code on the immobiliser and if it matches, the immobiliser may be disarmed, but if it does not match, the immobiliser may remain armed. After an engine has been operating and is then turned off, the immobiliser may automatically go from a disarmed state to an armed state so that to restart the engine, a valid disarm code must be entered into the immobiliser.

In this way, theft of the vehicle may be made more difficult since the engine may only be started and the vehicle operated after the correct disarm code has been entered. The disarm code may be restricted to authorised vehicle users only (for example by disclosing the code only to authorised users, or giving the required key-fobs only to authorised users etc), so that anyone without a valid disarm code will not be able to disarm the immobiliser.

The increased security provided by a vehicle immobiliser may be sufficient to achieve insurance industry requirements, such as Thatcham quality assurance specifications, which may result in a reduction in insurance premiums.

DE4317118 A1 describes an immobiliser device for use with a motor vehicle, the immobiliser device being configured to block the use of the ECU whilst the immobiliser is locked. A security code is stored in the memory of the immobiliser device and to unlock the immobiliser, thereby unblocking the use of the ECU and enabling the engine to start, the operator must enter the security code via an input device. If the code entered by the operator fails to match the security code stored in the memory of the immobiliser device, the ECU will remain blocked and the operator will not be able to start the engine.

However, vehicles and immobiliser devices are vulnerable to theft in different ways at each stage of their life, including during manufacture of the vehicle at a factory; delivery of the immobiliser device as a replacement part; transportation of the vehicle to, and keeping at, a dealer; and during final ownership of the vehicle. Therefore, it may be desirable to engage the immobiliser at all stages of the life of the vehicle and immobiliser in order to provide additional theft protection. However, this means that a large number of people will need to be given the security code, which is not only inconvenient, for example because many different people may need to move the vehicle during manufacture and transportation to the dealer, but also represents a security risk.

### SUMMARY

In a first aspect of the present disclosure there is provided: a vehicle immobiliser comprising: an input; and an output for preventing or allowing an operation of a vehicle; wherein the vehicle immobiliser is configured to: prevent an operation of the vehicle when the vehicle immobiliser is armed and allow an operation of the vehicle when the vehicle immobiliser is disarmed; and operate in one of a plurality of life-states, such that: when the vehicle immobiliser is armed and in a first life-state, meeting a first disarming condition at the input disarms the vehicle immobiliser; and when the vehicle immobiliser is armed and in a second life-state, meeting a second disarming condition at the input disarms the vehicle immobiliser.

In a second aspect of the present disclosure there is provided: a method for preventing or allowing an operation of a vehicle comprising a vehicle immobiliser, wherein the vehicle immobiliser is configured to operate in one of a plurality of life-states and is further configured to prevent the operation of the vehicle when the vehicle immobiliser is armed and allow an operation of the vehicle when the vehicle immobiliser is disarmed, the method comprising the steps of, when the vehicle immobiliser is initially armed: disarming the vehicle immobiliser when the vehicle immobiliser is in a first life-state and a first disarming condition is met at an input of the vehicle immobiliser; and disarming the vehicle immobiliser when the vehicle immobiliser is in a second life-state and a second disarming condition is met at the input of the vehicle immobiliser.

### BRIEF DESCRIPTION OF THE DRAWINGS

Aspects of the present disclosure shall now be described, by way of example only, with reference to the following drawings in which:

FIG. 1 shows a schematic representation of a vehicle comprising a vehicle immobiliser, an electronic vehicle control system, an internal combustion engine, a hydraulic system and a transmission system; and

FIG. 2 shows a representation of transitions between life-states of the vehicle immobiliser of FIG. 1.

FIG. 3 shows a representation of an example of the vehicle of FIG. 1.

### DETAILED DESCRIPTION

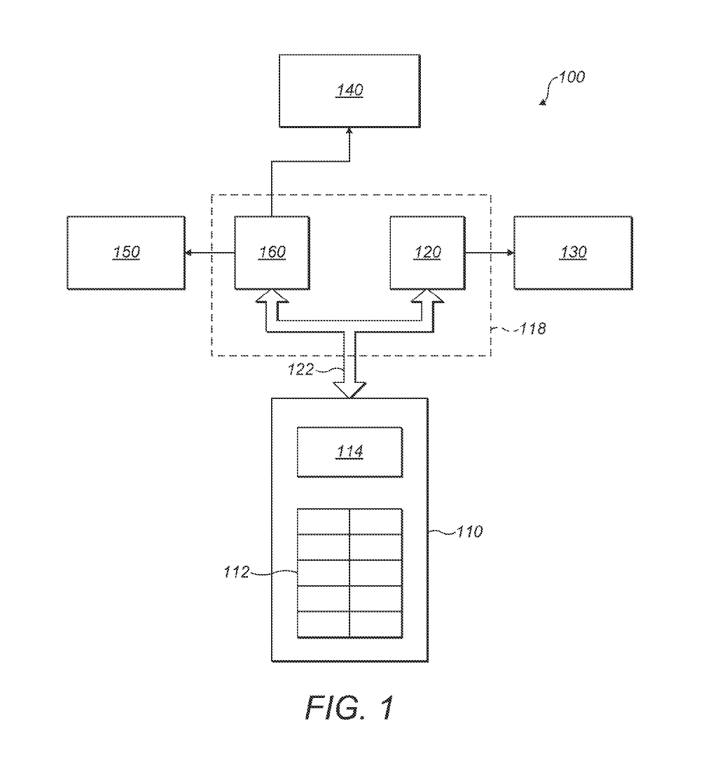

FIG. 1 shows a schematic representation of a vehicle 100, for example an earth-moving machine such as that defined in EN ISO6165:2012, comprising a vehicle immobiliser 110 that is in communication with an electronic vehicle control system 118, comprising an engine control unit (ECU) 120 and a machine control module (ECM) 160, via coded messages over a controller area network (CAN) bus 122. Communication between the vehicle immobiliser 110 and the electronic vehicle control system 118 may be encrypted in order to provide secure communication. The ECU 120 may control the operation of an internal combustion engine 130, for example a diesel engine, and the ECM 160 may control any other components that form part of the vehicle 100, for example a hydraulics system 140, which may comprise hydraulically powered peripheral devices such as a backhoe if the vehicle 100 is an earth-moving machine, and a vehicle transmission 150, for example a gear box.

The vehicle immobiliser 110 may be configured to prevent operation of the vehicle 100 when the vehicle immobiliser 110 is in an armed state. It may do this by instructing the ECU 120 and ECM 160 to prevent the functioning of any parts of the vehicle 100 that need to function in order for the vehicle 100 to operate. For example, the vehicle immobiliser 110 may instruct the ECU 120 via the CAN bus 122 not to turn the starter motor in response to an ignition signal from the operator and/or disable the fuel injectors in the internal combustion engine 130. The vehicle immobiliser 110 may also, or alternatively, instruct the ECM 160 via the CAN bus 122 to disable the hydraulics system 140 and/or lock the transmission 150. Thus, whilst the vehicle immobiliser 110 is in the armed state, the ECM 160 and ECU 120 may not respond to any vehicle operator requests, for example to start the internal combustion engine 130 or operate any hydraulically powered peripheral components, thus preventing any vehicle operations.

The vehicle immobiliser 110 may have a keypad 112 comprising a plurality of buttons/keys for entering a key code to disarm the vehicle immobiliser 110, for example 5 or 10 buttons/keys configured for entry of numbers between ‘0’-‘9’.

The vehicle immobiliser 110 has a number of different life-states in which it operates and it may have a visual indicator 114 that may inform the operator which life-state the vehicle immobiliser 110 is currently in. The visual indicator may also indicate if the vehicle immobiliser 110 is armed or disarmed.

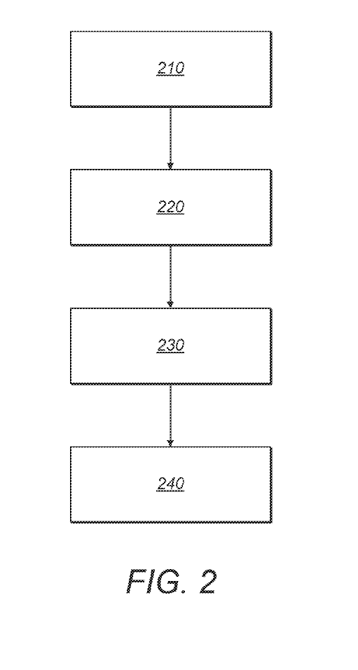

FIG. 2 shows a representation of four life-states in which the vehicle immobiliser 110 may be configured to operate. Each life-state may be a different operating mode of the vehicle immobiliser 110, wherein each operating mode that is configured for a particular time in the life of the vehicle immobiliser 110 and vehicle 100. In each life-state the vehicle immobiliser 110 may be responsive to different inputs, for example it may be disarmed using different codes, and may control the ECU 120 and ECM 160 differently. Once the vehicle immobiliser 110 or vehicle 100 completes one phase of its life and enters a new phase, for example after the vehicle 100 has been delivered to the owner and it leaves the delivery phase of its life and enters the operation phase of its life, an authorised user who knows the required transition conditions, for example vehicle immobiliser input codes, may transition the vehicle immobiliser 110 to the next life-state, which is configured for the new phase of the vehicle immobiliser 110 and vehicle 100 life.

The first life-state 210 may be a ‘new’ life-state, where the keypad is delivered to a vehicle manufacturer for fitting to the vehicle 100 during vehicle manufacture, or to the manufacturer's dealer for retrofitting to a vehicle. The vehicle immobiliser 110 may be in a dormant state in the new life-state 210, ready for configuration and fitting to the vehicle 100. The new life-state 210 may be configured such that whilst in the new life-state 210, the manufacturer of the vehicle immobiliser 110 may perform internal testing on the vehicle immobiliser 110 before delivery to the vehicle manufacturer for fitting to the vehicle 100 during vehicle manufacture, or the manufacturer's dealer for retrofitting to a vehicle.

The second life-state 220 may be a ‘configuration and fitting’ life-state, in which the vehicle immobiliser 110 may be configured for use with a particular vehicle 100 and fitted to the vehicle 100. In order to transition from the new life-state 210 to the configuration and fitting life-state 220, a first transition condition may need to be met comprising simultaneous and/or sequential immobiliser input elements. The first transition condition may comprise at least one of a first simultaneous combination of digits into the keypad 112 for a required period of time, for example the simultaneous pressing of digits ‘2’ and ‘5’ for a five second period, an application of a voltage meeting a first voltage condition, for example 5V, at an auxiliary voltage input to the vehicle immobiliser 110, and entry of a first transition condition key code into the keypad 112. Where two different keypad entry requirements are part of the first transition condition, for example entry of the first transition condition key code and entry of a first simultaneous combination of digits, the two different keypad entry requirements may be entered consecutively, in which case the order in which the two different keypad entry requirements are entered (i.e. entering the first transition condition key code before the first simultaneous combination of digits, or vice-versa) may also form part of the transition condition. Where a first voltage condition and at least one keypad entry requirement are part of the first transition condition, it may be arranged that the first voltage condition must be met during entry of the at least one keypad entry requirement.

The first transition condition key code may, for example, be a multi-digit authentication code that is applicable for all vehicle immobilisers of this type, or it may be unique to each different vehicle immobiliser 110. Likewise, the first simultaneous combination of digits may be applicable for all vehicle immobilisers of this type, or it may be unique to each different vehicle immobiliser 110.

Having entered the configuration and fitting life-state 220, the vehicle immobiliser 110 may be fitted to and configured for a particular vehicle. Where the vehicle 100 uses an ECU 120 for control of the internal combustion engine 130 and an ECM 160 for machine control, for example control of the hydraulics system 140 and transmission 150, and has a CAN bus 122, the vehicle immobiliser 110 may be connected into the CAN bus 122 for configuration.

Two-way communication may take place over the CAN bus 122 so that the vehicle immobiliser 110 may determine the type of ECM 160 and ECU 120 that it is communicating with and therefore what communication protocols are applicable and what commands are necessary for engine and machine control. The ECU 120 and ECM 160 may also identify the particular vehicle immobiliser 110 from which they should take commands.

A token exchange may take place between the vehicle immobiliser 110 and the ECU 120 and ECM 160, which pairs the vehicle immobiliser 110 with the ECU 120 and ECM 160 and enables subsequent communication via the CAN bus 122. Consequently, if in a later life-state, for example the ‘operations’ life-state (as explained below), the vehicle immobiliser 110 is replaced with a different vehicle immobiliser that is also in its operations life-state, the replacement vehicle immobiliser will not be able to instruct the ECU 120 and ECM 160 since it will not have been through the configuration and fitting life-state 220 with the ECU 120 and ECM 160 and will not, therefore, have been paired with the ECU 120 and ECM 160. Consequently, a would-be thief will not be able to overcome an armed vehicle immobiliser 110 simply by replacing it with a different vehicle immobiliser for which they know the disarming code because the replacement vehicle immobiliser will not be able to instruct the ECU 120 or ECM 160 to allow vehicle operations.

Whilst in the configuration and fitting life-state 220, the vehicle immobiliser 110 may be disabled using a disable code, for example, pressing and holding a particular combination of keys on the keypad 112 for a particular period of time. By disabling the vehicle immobiliser 110, the vehicle immobiliser 110 may be prevented from arming so that the vehicle 100 may be tested and built by the manufacturer without requiring any code entry into the vehicle immobiliser 110 to disarm the vehicle immobiliser 110.

Whilst in the configuration and fitting life-state 220, a computing device (for example a laptop), which may comprise an authentication software application, may be connected to the vehicle immobiliser 110, ECU 120 and ECM 160 via the CAN bus 122 and be used to set up and configure the vehicle immobiliser 110, ECU 120 and ECM 160. When the computing device is connected to the vehicle immobiliser 110 via the CAN bus 122, it may be configured to authenticate itself to the vehicle immobiliser 110 using, for example, a factory password or ‘Feature Protection’ password system software on the computing device. The computing device may be configured to automate the configuration process such that less manual input to the vehicle immobiliser 110 is required of the person carrying out the configuration.

Upon completion of configuration and fitting of the vehicle immobiliser 110, the vehicle immobiliser 110 may be transitioned by the manufacturer to the third life-state 230—the ‘transportation’ life-state—for example by pressing and holding a particular combination of keys on the keypad 112 for a particular period of time. Where a computing device is connected to the vehicle immobiliser 110 via the CAN bus 122, the computing device may carry out the transaction to the transportation life-state 230, either automatically after configuration is complete, or upon instruction from an operator.

In the transportation life state 230, the vehicle immobiliser 110 may be configured such that the disarming condition may be a transportation code, for example a multi-digit code, entered into the keypad 112 in order to disarm the vehicle immobiliser 110. The transportation code may be a default code programmed into the vehicle immobiliser 110 when it was made, in which case it may be unique to each individual vehicle immobiliser or it may be common to all vehicle immobilisers of this type, or it may be assigned by the vehicle manufacturer during configuration and fitting, in which case it may be a code that the vehicle manufacturer uses for all of their vehicles, or a code that is unique to the vehicle 100.

The vehicle immobiliser 110 may operate in the transportation life-state 230 whilst the vehicle 100 is still at the factory and whilst it is being moved from the factory to a dealer. The vehicle immobiliser 110 may be configured to disarm only a limited number of times, for example 100 times, whilst in the transportation life-state 230. As such, even if a third party had access to the transportation code, whether the transportation code is unique to the vehicle immobiliser 110 or common to all vehicle immobilisers of this type, and stole the vehicle 100 using the transportation code, they would only have limited use of the vehicle 100 since after the vehicle immobiliser 110 has been disarmed the limited number of times, it can no longer be disarmed using the transportation code and the vehicle 100 will become useless.

The vehicle immobiliser 110 may also be configured such that when in the transportation life-state 230, the vehicle immobiliser 110 may be disabled using a disable code, for example the simultaneous entry of two digits for a particular period of time, such as pressing ‘7’ and ‘9’ for 5 seconds, and entering the transportation code. Disabling the vehicle immobiliser 110 would prevent the vehicle immobiliser 110 from arming so that the vehicle 100 may be operated without the operator needing to disarm the vehicle immobiliser 110. The vehicle immobiliser 110 may then be enabled by entering an enable code, which may be the same as the disable code, or may be different.

Once the vehicle 100 has arrived at a dealer and the dealer has sold the vehicle 100 to the owner, the dealer may transition the vehicle immobiliser 110 from the transportation life-state 230 to the fourth life-state 240—the ‘operations’ life-state—before the owner takes the vehicle 100.

The dealer may begin the transition to the operations life-state 240 by entering at least one of the following into the keypad 112: a third transition condition key code and a third simultaneous combination of digits for a required period of time. The third transition condition key code may be the same as the first transition condition key code described earlier and/or the third simultaneous combination of digits may be the same as the first simultaneous combination of digits. Alternatively, the third transition condition key code and/or the third simultaneous combination of digits may be different from all other key codes and simultaneous combination of digits described above, or, for example, the third transition condition key code may be the same as the first transition condition key code and the third simultaneous combination of digits different to all earlier described simultaneous combination of digits, or vice-versa.

Having done this, the dealer may assign his own dealer-code into the vehicle immobiliser 110 memory by entering it into the keypad. Entry of the dealer-code into the keypad 112 may then be a disarming condition during the operations life-state 240 such that the dealer may use the dealer-code to disarm the vehicle immobiliser 110 so that the dealer may operate the vehicle 100, for example to move it around their premises, and perform any required vehicle servicing, either before hand-over to the owner or during the life-time of the vehicle as part of a service arrangement. The dealer may assign a dealer-code that they use for all vehicles that they sell and/or service, or they may assign a different dealer code for each vehicle.

The dealer may then assign an owner key code. The owner-code may be chosen by the owner and entry of the owner-code into the keypad 112 may be a disarming condition during the operations life-state 240 for use by the owner after taking delivery of the vehicle 100 to disarm the vehicle immobiliser 110. Alternatively, or additionally, the owner-code may be used during the operations life-state 240 to add, delete or reassign user codes (described below). In this way, the owner code may function as an owner master code in the operations life-state 240.

Having assigned the owner-code, the dealer may then also assign a first user-code and, if required, a plurality of further user-codes, for example up to 25 user codes. Entry of the owner-code into the keypad 112 may be a disarming condition for use by a user during the operations life-state 240 to disarm the vehicle immobiliser 110 and a plurality of user codes may be assigned, each one for a different authorised user of the vehicle 100.

In order to enter the above described third transition condition and assign the above described codes, rather than using the keypad 112 the dealer may connect a computing device (for example a laptop), which may comprise an authentication software application, to the vehicle immobiliser 110 via the CAN bus 122 and enter the necessary information via the computing device. The computing device may optionally also be configured such that when it is connected to the vehicle immobiliser 110 via the CAN bus, it may authenticate itself to the vehicle immobiliser 110 using a ‘Feature Protection’ password system software on the computing device. The computing device may also be configured to enter the necessary information, for example the third transition condition and assignment of the codes, automatically without requiring manual entry from the dealer. Furthermore, the computing device may also, or alternatively, be configured to examine the passcodes held in the immobiliser 110 and to change them, optionally after authenticating itself to the vehicle immobiliser 110 using the ‘Feature Protection’ password system. Additionally or alternatively, the computing device may be configured to carry out any necessary service diagnostics and calibration etc, so the dealer may use the computing device whenever servicing the vehicle 100.

The action of assigning a dealer-code and an owner-code, and optionally also a first user-code and a plurality of further user-codes, by the dealer may complete the transition of the vehicle immobiliser 110 out of the transportation life-state 230 into the operations life-state 240, at which time the dealer may pass the vehicle 100 on to the owner. Upon entering the operations life-state 240, the transportation code and the trip counter (i.e. the tally of how many times the vehicle immobiliser 110 has been disarmed in the transportation life-state 230) may be deleted from the vehicle immobiliser 110 so that the transportation code can no longer be used to disarm the vehicle immobiliser 110.

The vehicle immobiliser 110 may also be configured such that the number of times the dealer-code can consecutively disarm the vehicle immobiliser 110 without an interceding user or owner code being entered is limited.

Whilst in the transportation life-state 230 or operations life-state 240, if a would-be thief were to remove the vehicle immobiliser 110 and replace it with a different vehicle immobiliser in the transportation or operation life-state and for which they knew the transportation, dealer, user or owner-code (as applicable), because the different vehicle immobiliser had not been paired with the ECM 160 or ECU 120 during the configuration and fitting life-state 220, the different vehicle immobiliser may not be able to instruct the ECM 160 or ECU 120 to allow vehicle operations. Therefore, the vehicle 100 would remain immobilised and the would-be thief would not be able to take control of the vehicle 100.

If a would-be thief were to obtain a vehicle immobiliser in the new life-state 210, they may replace a vehicle immobiliser 110 fitted to a vehicle 100 with the vehicle immobiliser in the new life-state 210 in order to try to steal the vehicle 100. However, they may only be successful if they know and are able to meet all of the different transition conditions required to transition the newly fitted vehicle immobiliser through all of the different life-states for which the vehicle immobiliser 110 is configured, i.e. from the new life-state 210 to the configuration and fitting life-state 220 to the transportation life-state 230 and finally to the operations life-state 240.

Furthermore, the dealer-code and/or owner-code and/or the first user-code may be registered with the relevant authorities, for example under the CESAR system, such that if the vehicle is recovered after a theft, it may be moved and returned by the authorities

The visual indicator 114 on the vehicle immobiliser 110 may indicate which life-state the vehicle immobiliser 110 is in so that the operator may be aware of which operations may be performed and what type of codes should be entered in order to disarm the vehicle immobiliser 110 or transition the vehicle immobiliser 110 to the next life-state. It may also indicate to the operator whether the vehicle immobiliser 110 is armed or disarmed. The visual indicator 114 may be of any type that can convey such information, for example it may be one or more LEDs or bulbs of the same or different colours, or a graphical display, such as an LCD screen etc.

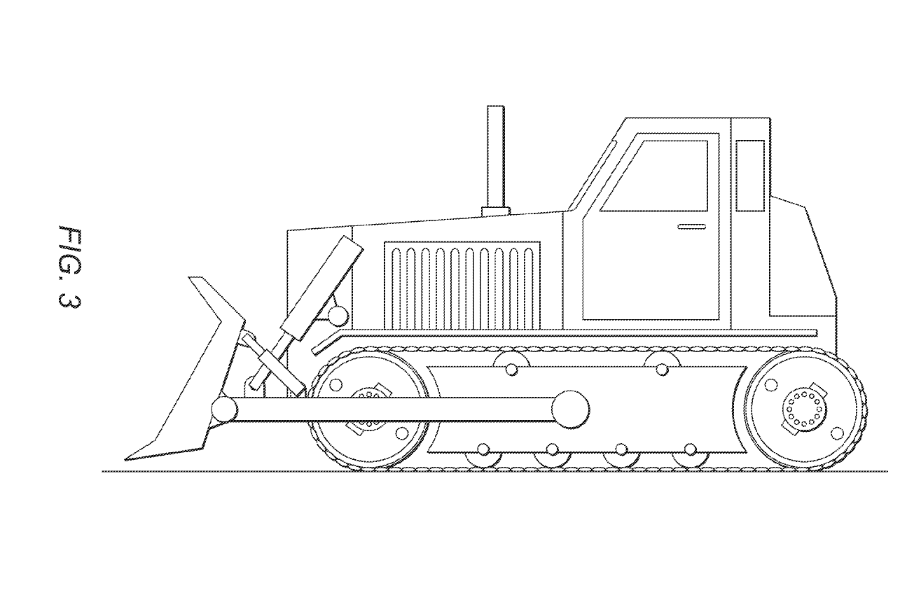

FIG. 3 shows an example vehicle 100.

Various alternatives to the above described aspects of the present disclosure may be appreciated by the skilled person.

For example, the vehicle immobiliser 110 in the above described aspects is configured to communicate via a CAN bus 122 with an ECM 160 that is set up to control the machine operations (i.e. hydraulics system 140 and transmission 150) and an ECU 120 that is set up to control the internal combustion engine 130 operations. However, some vehicles may not have an ECM or ECU with which to control either machine or engine operations. The vehicle immobiliser 110 may therefore have one or more output drivers for use with such vehicles. For example, the vehicle immobiliser 110 may have four output drivers, which during installation of the vehicle immobiliser 110, either during vehicle 100 manufacture or immobiliser retrofitting, may be connected to, and control the operation of, the engine starter motor, the engine fuelling system, the transmission 150 and the hydraulics system 140. The vehicle immobiliser 110 may then be configured during the configuration and fitting life-state 220 to control operation of these vehicle components accordingly whilst armed and disarmed. Thus, even without an ECU 120 or ECM 160, the vehicle immobiliser 110 may still immobilise the vehicle when armed and allow vehicle 100 operations when disarmed.

Furthermore, some vehicles may have an electronic vehicle control system 118 with an ECU 120 for controlling only the internal combustion engine 130, but not an ECM 160 for controlling machine operations, such as the hydraulics system 140 or transmission 150. Likewise, some vehicles may have an electronic vehicle control system 118 with an ECM 160 for controlling at least some machine operations, but not an ECU 120 for controlling operation of the internal combustion engine 130. In this case, the CAN bus 122 may be used by the vehicle immobiliser 110 to communicate with and instruct the operation of the ECU 120 or ECM 160 (as applicable), and vehicle immobiliser output drivers may be used to control the operation of any vehicle components not controlled by an ECU 120 or ECM 160.

Whilst communication between the vehicle immobiliser 110 and the ECU 120 and ECM 160 takes place via a CAN bus 122 in the above described aspects, the communication may alternatively take place by any data communication means.

In the above described aspects, when the vehicle immobiliser 110 is armed, all engine and machine operations are blocked, and when the vehicle immobiliser 110 is disarmed, all engine and machine operations are allowed. However, the vehicle immobiliser may be configured such that in the armed state only some engine and/or machine operations are blocked whilst others are allowed, and/or in the disarmed state only some engine and/or machine operations are allowed whilst others are blocked. Furthermore, the engine and machine operations that are allowed or blocked may be different for each life-state. For example, in the transportation life-state 230, when the vehicle immobiliser 110 is disarmed the internal combustion engine 130 and transmission 150 may be allowed to operate whilst the hydraulics system 140 may be blocked from operation, but in the operations life-state 240, all engine and machine operations may be allowed when the vehicle immobiliser 110 is disarmed. Furthermore, where different codes may disarm the vehicle immobiliser 110, for example the dealer and user codes in the operations life-state 240, the engine and machine operations that are allowed may be different depending on which code has disarmed the vehicle immobiliser 110. For example the dealer code may result in only the internal combustion engine 130 being allowed to operate so that engine servicing can take place whilst still preventing vehicle movement, whereas disarming using a user code may result in all engine and machine operations being allowed.

Furthermore, the vehicle immobiliser 110 may be configured to allow engine and machine operations only to a limited extent when armed and/or disarmed and the extent to which operations are allowed when in an armed and/or disarmed state may be different depending on which life-state the vehicle immobiliser 110 is in. For example, whilst in the transportation life-state, disarming the vehicle immobiliser 110 may allow the internal combustion engine 130 to operate up to a limited maximum engine speed and/or limit the gears available in the transmission 150 only to low gears, whereas in the operations life-state, disarming the vehicle immobiliser 110 may allow engine and machine operations to operate to their full extent.

The vehicle 100 described in the above aspects of the disclosure may not comprise an internal combustion engine 130, a hydraulics system 140 and a transmission 150, but may instead comprise fewer or more components, each of which may be controlled by an ECU 120 or an ECM 160, or by vehicle immobiliser drivers. Furthermore, the ECU 120 and ECM 160 may be implemented as separate electronic devices, or form separate parts of a single electronic vehicle control system 118, or the functionality of the ECU 120 and ECM 160 may be combined and executed by a single electronic control device.

Whilst in the above described aspects the keypad 112 is a numeric keypad, it may instead be an alphanumeric keypad, or a keypad with only letters or any other symbols.

Furthermore, the codes required to execute transition of the vehicle immobiliser 110 to its next life-state, or to disarm the vehicle immobiliser 110, may be of any length.

In addition to, or as an alternative to, using a keypad 112 to input the various codes into the vehicle immobiliser 110, any other means of code entry may be used. For example, a wireless key-fob, RFID tag or similar may be used for the entry of at least some of the codes, wherein the manufacturer may have a suitable key fob(s) with the code(s) they require, the dealer may have a suitable key fob(s) with the code(s) they require, the owner may have a suitable key fob(s) with the code(s) they require and each user may have a suitable key fob with the code they require. Furthermore, in addition to the different codes described in the present disclosure, use of a wireless key-fob, RFID tag or similar may be required to disarm the vehicle immobiliser 110 or transition the vehicle immobiliser 110 to the next state. For example, dealers may each be issued with a wireless key-fob, which may be required in addition to the conditions described above in order to transition the vehicle immobiliser 110 from the transportation life-state 230 to the operations life-state 240.

Some insurance standards, for example those set in the Thatcham quality assurance specifications, may specify a minimum attack time that the vehicle immobiliser 110 should withstand from a would be thief, for example a 15 minute attack, before the thief can disarm the vehicle immobiliser 110. The vehicle immobiliser 110 may accordingly be configured such that transitions from one life-state to the next take a least the minimum attack time, for example by introducing a 15 minute delay period into the transition process. Thus, a would be thief who installs a replacement vehicle immobiliser in, for example, the new life-state 210, would not be able to meet all of the different transition conditions required to transition the newly fitted vehicle immobiliser through all of the different life-states for which the vehicle immobiliser 110 is configured, i.e. from the new life-state 210 to the configuration and fitting life-state 220 to the transportation life-state 230 and finally to the operations life-state 240, within the minimum attack period, even if they knew all of the different transition conditions.

Whilst in the above described aspects of the disclosure there are four different life-states in which the vehicle immobiliser 110 may operate, the vehicle immobiliser 110 may be configured to have any number of life-states in which it may operate, for example there may be two, three, five or six life-states, or more. As described above, the vehicle immobiliser 110 may be disarmed with a different code in each different life-state and the vehicle immobiliser 110 may transition from one life-state to the next by meeting different transition conditions for each life-state.

Furthermore, in any life-state, the number of times that the vehicle immobiliser 110 may be disarmed may be limited, for example to 100 times, and/or the extent of allowable engine and vehicle operations may be limited, for example by preventing all hydraulic usage, or by limiting the maximum allowable internal combustion engine speed or the allowable gears in the transmission 150. By doing so, the disarming conditions for a particular life-state may be reduced, for example to a code with few digits, in order to make vehicle operation more straightforward during that part of the vehicle 100 life.

### INDUSTRIAL APPLICABILITY

The present disclosure provides a vehicle immobiliser and a method for preventing or allowing an operation of a vehicle comprising the vehicle immobiliser. The vehicle immobiliser is configured to operate in one of a plurality of life states, wherein different disarming conditions may need to be met for each life state in order to disarm the vehicle immobiliser and different vehicle operations may be allowed by the vehicle immobiliser for each life state. Thus, different levels of security may be provided by the vehicle immobiliser throughout the life-time of the vehicle, from initial manufacture through to the final ownership of the vehicle, which may improve security without causing unreasonable hindrance at certain points in the life of the vehicle. Furthermore, it may also be more difficult simply to replace the vehicle immobiliser installed on a vehicle with an ECU and/or ECM with a new vehicle immobiliser in order to work around the security because the replacement immobiliser will not have been through the life-state transitions with the ECU and/or ECM and may not, therefore, be able to instruct ECU and/or ECM operations.

1. A vehicle immobiliser comprising:
an input device configured to receive a code; and
an output device configured to issue an instruction to a controller of a vehicle,
wherein the vehicle immobiliser is configured to:
issue the instruction to prevent an operation of the vehicle when the vehicle immobiliser is armed;
issue the instruction to allow an operation of the vehicle when the vehicle immobiliser is disarmed; and
operate in one of a plurality of sequential life-states including a first life-state and a second life-state subsequent to the first life-state, the vehicle immobiliser being configured to enter the second life-state after being disarmed in the first life-state, such that:
when the vehicle immobiliser is armed and in a first life-state, the vehicle immobiliser is configured to be disarmed upon receiving the code that satisfies a first disarming condition; and
when the vehicle immobiliser is armed and in a second life-state, the vehicle immobiliser is configured to be disarmed upon receiving the code that satisfies a second disarming condition.

2. The vehicle immobiliser of claim 1, wherein the vehicle immobiliser permits an internal combustion engine of the vehicle to start when the vehicle immobiliser is disarmed.

3. The vehicle immobiliser of claim 1, wherein the vehicle immobiliser permits operation of a vehicle transmission when the vehicle immobiliser is disarmed.

4. The vehicle immobiliser of claim 1, wherein the vehicle immobiliser permits operation of a vehicle hydraulics system when the vehicle immobiliser is disarmed.

5. The vehicle immobiliser of claim 1, wherein when the vehicle immobiliser is in the first life-state, it may only be disarmed a limited number of times.

6. The vehicle immobiliser of claim 1, wherein transition of the vehicle immobiliser from the first life-state to the second life-state is executed when the code received by the input device satisfies a first life-state transition condition associated with the first life-state.

7. The vehicle immobiliser of claim 6, wherein the input device comprises at least one of a keypad and a computer and the code comprises a first life-state transition code input by an operator using the input device.

8. The vehicle immobiliser of claim 1, wherein
the input device comprises a keypad,
the first disarming condition is satisfied when the code received from the keypad is a first disarming code, and
the second disarming condition is satisfied when the code received from the keypad is a second disarming code.

9. The vehicle immobiliser of claim 1, wherein the vehicle immobiliser is further configured to operate in a configuration and fitting life-state, and wherein transition of the vehicle immobiliser from the configuration and fitting life-state to a subsequent sequential life-state is executed when the code received by the input device satisfies a configuration and fitting life-state transition condition.

10. The vehicle immobiliser of claim 9 further configured to pair with an electronic vehicle control system when the vehicle immobiliser is in the configuration and fitting life-state.

11. The vehicle immobiliser of claim 10 further configured to communicate with the electronic vehicle control system via coded messages over a CAN bus.

12. The vehicle immobiliser of claim 9, wherein the input device comprises at least one of a keypad and a computer and the configuration and fitting life-state transition condition is satisfied when the code received from the input device is a configuration and fitting life-state transition code.

13. The vehicle immobiliser of claim 9, wherein the vehicle immobiliser is further configured to operate in an initial life-state, and wherein transition of the vehicle immobiliser from the initial life-state to the configuration and fitting life-state is executed when the code received by the input device satisfies an initial life-state transition condition.

14. The vehicle immobiliser of claim 13, wherein the input device comprises a keypad and an auxiliary voltage input and the initial life-state transition condition is satisfied when an initial life-state transition voltage is applied to the auxiliary voltage input and the code received from the keypad is an initial life-state transition code.

15. The vehicle immobiliser of any preceding claim further comprising:
a visual indicator of the vehicle immobiliser life-state.

16. A vehicle comprising:
an internal combustion engine;
a hydraulics system;
a transmission; and
a vehicle immobilizer including:
an input device configured to receive a code; and
an output device configured to issue an instruction to a controller of a vehicle,
wherein the vehicle immobiliser is configured to:
issue the instruction to prevent an operation of the vehicle when the vehicle immobiliser is armed;
issue the instruction to allow an operation of the vehicle when the vehicle immobiliser is disarmed; and
operate in one of a plurality of sequential life-states including a first life-state and a second life-state subsequent to the first life-state, the vehicle immobiliser being configured to enter the second life-state after being disarmed in the first life-state, such that:
when the vehicle immobiliser is armed and in a first life-state, the vehicle immobiliser is configured to be disarmed upon receiving the code that satisfies a first disarming condition; and
when the vehicle immobiliser is armed and in a second life-state, the vehicle immobiliser is configured to be disarmed upon receiving the code that satisfies a second disarming condition.

17. A method for preventing or allowing an operation of a vehicle comprising a vehicle immobiliser, the method comprising the steps of:
operating the vehicle immobiliser in one of a plurality of life-states;
disarming the vehicle immobiliser when the vehicle immobiliser is initially armed, when the vehicle immobiliser is in a first life-state, and when a code entered using an input device associated with the vehicle immobiliser satisfies a first disarming condition; and
disarming the vehicle immobiliser when the vehicle immobiliser is initially armed, when the vehicle immobiliser is in a second life-state, and when the code entered using an input device associated with the immobiliser satisfies a second disarming condition.

18. The vehicle of claim 16, wherein the vehicle immobiliser is configured to permit the internal combustion engine of the vehicle to start when the vehicle immobiliser is disarmed.

19. The vehicle of claim 16, wherein the vehicle immobiliser is configured to permit operation of the transmission when the vehicle immobiliser is disarmed.

20. The vehicle of claim 16, wherein the vehicle immobiliser is configured to permit operation of the vehicle hydraulics system when the vehicle immobiliser is disarmed.
